(19) United States
(12) Patent Application Publication
(10) Pub. No.: US 2016/0164970 A1
(43) Pub. Date: Jun. 9, 2016

(54) Application Synchronization Method, Application Server and Terminal

(71) Applicant: ZTE CORPORATION, Shenzhen City, Guangdong Province (CN)

(72) Inventor: Cheng HUANG, Shenzhen (CN)

(21) Appl. No.: 14/893,076

(22) PCT Filed: Oct. 14, 2013
(86) PCT No.: PCT/CN2013/085154

§ 371 Date: Dec. 29, 2015

(30) Foreign Application Priority Data
May 25, 2013 (CN) 201310199006.1

(51) Int. Cl. H04L 29/08

(52) U.S. Cl. CPC H04L 67/1095

(57) ABSTRACT

An application synchronization method, an application server and a terminal are disclosed. The method includes: an application server receiving a request for acquiring associated contents associated with first terminal primary content sent by a first terminal or a second terminal; the application server accessing content viewing information of the first terminal primary content; and the application server acquiring the associated contents according to the content viewing information and returning the associated contents to the first terminal and/or the second terminal. With the application synchronization method, the application server and the terminal in the embodiments of the present invention, a simple and effective scheme of synchronizing the associated contents with the primary content is provided.

### TECHNICAL FIELD

The scheme of the present document relates to the field of mobile communication technology, and particularly, to an application synchronization method, an application server and a terminal.

### BACKGROUND OF THE RELATED ART

The way of people watching television is changing, and the way of traditional passive receiving is turned into an interactive and participative experience. More and more consumers use their second terminal such as a smartphone, a tablet computer and a laptop to search, interact and participate in a variety of applications, communities and websites of the second screen while watching television programs.

With the Automatic Content Recognition (ACR) technology, the automatic recognition and precise synchronization can be performed between the Primary Content of first terminal screen (i.e. a first screen), such as a television program, and a second screen application, and the program producer, content provider and advertising agency are allowed to provide more event-based immersive visual experiences, which enhances the viscidity and audience participation of the programs, and greatly improves the television viewing experience, and becomes a catalyst for driving the content consumption.

An Interactive Content relative to the primary content is also called an Associated Content, and it can be displayed to the users on the second screen. The accurate discovery and real-time acquisition of the associated contents and the synchronous display between the primary content and the associated contents of the second screen are the key for successful operation of the second screen application, and two types of technologies are widely mentioned and executed at present: 1) the content producer adds specific associated contents metadata in the program signals, and whereby establishes a logical relation between the associated contents and the primary content; 2) the application terminal extracts characteristics of the program content that is being broadcasted, and then identifies the associated contents of the second screen application required to be acquired.

However, the above technical scheme has a series of problems such as the high production cost of the program content, the complicated computation of the terminal application and the system interaction delay and so on in the practical deployment, which needs to be further studied and solved.

### SUMMARY OF THE INVENTION

The present document provides an application synchronization method, an application server and a terminal, to solve the existing problem of the complicated scheme for implementing synchronization of the associated contents in the second screen application.

In order to solve the above technical problem, the present document provides a method for application synchronization, which comprises:

an application server receiving a request for acquiring associated contents associated with a first terminal primary content sent by a first terminal or a second terminal;

the application server accessing content viewing information of the first terminal primary content; and

the application server acquiring the associated contents according to the content viewing information and returning the associated contents to the first terminal and/or the second terminal.

Preferably, before the step of the application server accessing content viewing information of the first terminal primary content, the method further comprises: the application server interacting with a third-party support server, and subscribing to a presence state of the first terminal primary content; and

the application server accessing the content viewing information of the first terminal primary content based on the presence state of the primary content.

Preferably, the request for acquiring the associated contents carries the content viewing information of the first terminal primary content, and the application server accesses the content viewing information of the first terminal primary content based on the request for acquiring the associated contents.

Preferably, the step of the application server acquiring the associated contents according to the content viewing information comprises:

the application server maintaining an association relation between the first terminal primary content and the associated contents;

the application server determining the first terminal primary content according to the content viewing information; and

the application server acquiring associated contents associated with the first terminal primary content based on the association relation.

Preferably, the content viewing information at least comprises one of the following: content metadata, a viewing progress and contents view characteristics.

Preferably, the content metadata comprise a channel ID or a program ID; the viewing progress comprises a viewing status or elapsed time; and the contents view characteristics comprise a digital fingerprint or a digital watermark.

Preferably, the content viewing information is the contents view characteristics, and the step of the application server determining the first terminal primary content according to the content viewing information comprises:

the application server requesting a content recognition server to recognize the first terminal primary content according to the contents view characteristics; and

the application server determining the first terminal primary content according to a recognition result of the content recognition server.

Preferably, the application server acquires a plurality of different associated contents associated with the first terminal primary content; and

the application server returns one or a plurality of associated contents in the plurality of different associated contents to the first terminal and/or the second terminal.

In order to solve the above technical problem, the present document further provides a method for application synchronization, which comprises:

a first terminal or a second terminal sending a request for acquiring associated contents associated with first terminal primary content to an application server; and

the first terminal or the second terminal receiving associated contents returned by the application server, wherein the associated contents are acquired by the application server according to content viewing information of the first terminal primary content.

Preferably, before the step of the first terminal sending the request for acquiring the associated contents, the method further comprises: the first terminal acquiring the content viewing information of the first terminal primary content; wherein the request for acquiring the associated contents carries the content viewing information.

Preferably, before the step of the second terminal sending the request for acquiring the associated contents, the method further comprises: the second terminal receiving the content viewing information sent by the first terminal;

wherein the request for acquiring the associated contents carries the content viewing information.

Preferably, the content viewing information at least comprises one of the following: content metadata, a viewing progress and contents view characteristics.

Preferably, before the step of the second terminal sending the request for acquiring the associated contents, the method further comprises: the second terminal acquiring the content viewing information, wherein the content viewing information is contents view characteristics; and the request for acquiring the associated contents carries the contents view characteristics.

Preferably, the content metadata comprise a channel ID or a program ID; the viewing progress comprises a viewing status or elapsed time; and the contents view characteristics comprise a digital fingerprint or a digital watermark.

Preferably, the first terminal and/or the second terminal receive one or a plurality of associated contents in a plurality of different associated contents acquired by the application server.

In order to solve the above technical problem, the present document further provides an application server, which comprises:

a contents guide function, configured to: receive a request for acquiring associated contents associated with first terminal primary content sent by a first terminal or a second terminal, and send associated contents acquired by an associated contents function to the first terminal and/or the second terminal;

a multi-device discovery function, configured to: access content viewing information of the first terminal primary content; and

an associated contents function, configured to: acquire the associated contents according to the content viewing information.

In order to solve the above technical problem, the present document further provides a terminal, which comprises:

a request sending unit, configured to: send a request for acquiring associated contents associated with primary content of a current terminal or associated terminal to an application server; and

an associated contents receiving unit, configured to: receive associated contents returned by the application server, wherein the associated contents is acquired by the application server according to content viewing information of the primary content.

With the application synchronization method, the application server and the terminal provided in the embodiments of the present invention, the terminal sends a request for acquiring associated contents associated with terminal primary content to the application server, and the application server acquires the associated contents associated with the terminal primary content by accessing content viewing information of the terminal primary content, which reduces the production cost of the primary content and the acquisition complexity of the associated contents, thereby implementing the scheme of efficiently synchronizing the associated contents in the second screen application.

### BRIEF DESCRIPTION OF DRAWINGS

FIG. 1 is a schematic diagram of an application synchronization method according to the embodiment 1 of the present invention.

FIG. 2 is a flow chart of an application server acquiring associated contents according to content viewing information in the flow of the embodiment of the present invention.

FIG. 3 is a schematic diagram of an application synchronization method according to the embodiment 2 of the present invention.

FIG. 4 is a schematic diagram of an application synchronization method according to the embodiment 3 of the present invention.

FIG. 5-7 are schematic diagrams of a modular structure of an application server according to the embodiment of the present invention.

FIG. 8 is a schematic diagram of an application synchronization method according to another embodiment of the present invention.

FIG. 9 is a schematic diagram of a modular structure of a terminal according to the embodiment of the present invention.

FIG. 10 and FIG. 11 are schematic diagrams of a structure of a system applying the method of the present invention according to the application example.

### PREFERRED EMBODIMENTS OF THE INVENTION

The application synchronization method of the embodiment of the present invention is mainly to receive a request for acquiring associated contents associated with primary content of a certain terminal based on an application server, and then access content viewing information of the primary content, and acquire the associated contents associated with the primary content. During the specific implementation, there can be various different implementation ways, the technical scheme of the present document will be further described in detail in combination with the accompanying drawings and specific embodiments below, so that the people skilled in the art can better understand the patent document and implement the patent document, but the illustrated embodiments are not a limitation to the patent document. It should be noted that the embodiments in the present invention and the characteristics in the embodiments can be combined with each other in the condition of no conflict.

### Embodiment 1

It is an application synchronization method according to the embodiment 1 of the present invention, in the embodiment 1, a terminal outputting the primary content is called a first terminal, and a terminal sending a request for acquiring associated contents and receiving the associated contents is another associated terminal different from the first terminal, and it is called a second terminal, and as shown in FIG. 1, the method includes the following steps.

In step 101, an application server receives a request for acquiring associated contents associated with a first terminal primary content sent by a second terminal.

The first terminal (such as a smart television set-top box) has an ability of receiving and broadcasting the multimedia contents, for example, a live television program is broadcasted on a first screen, and it is called the first terminal primary content or primary content. The second terminal (such as a smartphone or a tablet computer) similarly has the ability of receiving and broadcasting the multimedia contents, for example, it accesses an Internet video content and broadcasts the Internet video content on a second screen. The second terminal sends a request for acquiring associated contents, to request to acquire the associated contents corresponding to the first terminal primary content.

In the patent document, the associated contents are various multimedia contents in an association relation with the first terminal primary content, such as a text, a static image and an audio or video clip and so on, which is used for providing enhanced or supplemental information for the primary content which the user is watching.

Alternatively, the request for acquiring the associated contents carries content viewing information of the first terminal primary content. Specifically, the content viewing information of the first terminal primary content can be acquired by the first terminal acquiring the content viewing information of the primary content of the first terminal and sent to the second terminal.

In step 102, the application server accesses the content viewing information of the first terminal primary content.

When the request for acquiring the associated contents received by the application server carries the content viewing information, alternatively, the application server accesses the content viewing information of the first terminal primary content based on the request for acquiring the associated contents.

Another optional scheme is that, the request for acquiring the associated contents received by the application server does not carry the content viewing information, before the step of the application server accessing the content viewing information of the first terminal primary content, the application server interacts with a third-party support server, and subscribes to a presence state of the first terminal primary content; and at this point, the application server can access the content viewing information of the first terminal primary content based on the presence state of the primary content.

Alternatively, the content viewing information at least includes one of the following: content metadata, a viewing progress and contents view characteristics.

The content metadata include but are not limited to a Channel ID or a Program ID; the viewing progress includes but not limited to a viewing status or elapsed time; and the contents view characteristics include but not limited to a digital fingerprint or a digital watermark.

In step 103, the application server acquires the associated contents according to the content viewing information and returns the associated contents to the second terminal.

The application server requests a content storage server to acquire the associated contents based on the association relation; or, the application server acquires the associated contents from a local cache based on the association relation.

For example, when the first terminal is the set-top box, while the primary content is output, associated contents or a prompt related to the associated contents can be output at the corner or bottom of the television screen.

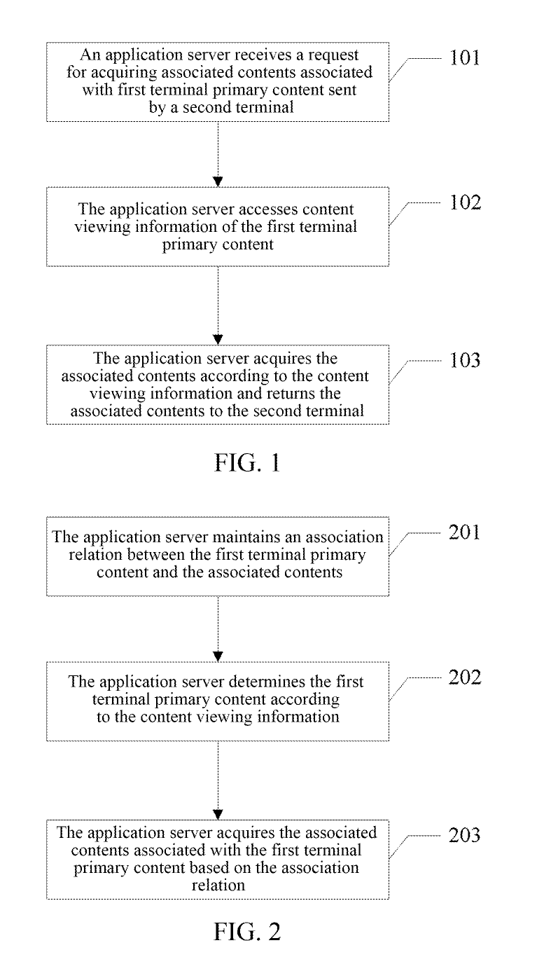

Specifically, as shown in FIG. 2, the step of the application server acquiring the associated contents according to the content viewing information includes the following steps.

In step 201, the application server maintains an association relation between the first terminal primary content and the associated contents.

In step 202, the application server determines the first terminal primary content according to the content viewing information.

When the content viewing information is the contents view characteristics, the step of the application server determining the first terminal primary content according to the content viewing information includes:

the application server requests a content recognition server to recognize the first terminal primary content according to the contents view characteristics; and

the application server determines the first terminal primary content according to a recognition result of the content recognition server.

Understandably, the content recognition server mentioned here is mainly used for implementing a content recognition function, and convertibly the content recognition function can be implemented by the application server itself, thereby voluntarily determining the first terminal primary content according to the content viewing information.

In step 203, the application server acquires the associated contents associated with the first terminal primary content based on the association relation.

Besides using the above preferred way to acquire the associated contents, the application server also can adopt other ways, for example, the application server initiates a search request to the third-party support server according to the content viewing information, and acquires associated contents meeting the condition according to a returned search result.

The application server returns one or a plurality of associated contents in the plurality of different associated contents to the second terminal. Alternatively, one or a plurality of associated contents in the plurality of different associated contents also can be returned to the first terminal at the same time.

### Embodiment 2

It is an application synchronization method according to the embodiment 2 of the present invention, in the embodiment 2, a terminal outputting the primary content is also a terminal sending a request for acquiring associated contents, and it is called a first terminal, but a terminal receiving the associated contents is the first terminal and/or another associated second terminal, and as shown in FIG. 3, the method includes the following steps.

In step 301, an application server receives a request for acquiring associated contents associated with first terminal primary content sent by a first terminal.

The first terminal (such as a smart television set-top box) has an ability of receiving and broadcasting the multimedia contents, for example, the broadcasted live television program is called the first terminal primary content or primary content. The first terminal sends a request for acquiring associated contents, to request to acquire the associated contents corresponding to the first terminal primary content.

In the patent document, the associated contents are various multimedia contents in an association relation with the first terminal primary content, such as a text, a static image and an audio or video clip and so on, which is used for providing enhanced or supplemental information for the primary content which the user is watching.

Alternatively, the first terminal acquires content viewing information of the primary content of the first terminal, and then the request for acquiring the associated contents carries the content viewing information of the first terminal primary content.

In step 302, the application server accesses the content viewing information of the first terminal primary content.

When the request for acquiring the associated contents received by the application server carries the content viewing information, the application server accesses the content viewing information of the first terminal primary content based on the request for acquiring the associated contents.

Another optional scheme is that, the request for acquiring the associated contents received by the application server does not carry the content viewing information, before the step of the application server accessing the content viewing information of the first terminal primary content, the application server interacts with a third-party support server, and subscribes to a presence state of the first terminal primary content; and at this point, the application server can access the content viewing information of the first terminal primary content based on the presence state of the primary content.

Alternatively, the content viewing information at least includes one of the following: content metadata, a viewing progress and contents view characteristics.

The content metadata include but not limited to a Channel ID or a Program ID; the viewing progress includes but not limited to a viewing status or elapsed time; and the contents view characteristics include but not limited to a digital fingerprint or a digital watermark.

In step 303, the application server acquires the associated contents according to the content viewing information and returns the associated contents to the first terminal and/or the second terminal.

Specifically, the application server can acquire the associated contents according to the content viewing information in the way identical with that in the embodiment 1.

The application server acquires a plurality of different associated contents associated with the first terminal primary content; and the application server returns one or a plurality of associated contents in the plurality of different associated contents to the first terminal and/or the second terminal.

Specifically, the plurality of different associated contents can be represented in the same or different forms, such as an audio, a video, a picture, a text or a connection and so on. The application server can deliver different associated contents according to the abilities of the first terminal and second terminal and the specific form of the associated contents, for example, when the associated contents is a connection, it can be returned to the smartphone, and if it is text information, it can be returned to the television and displayed at the top or bottom of the television.

### Embodiment 3

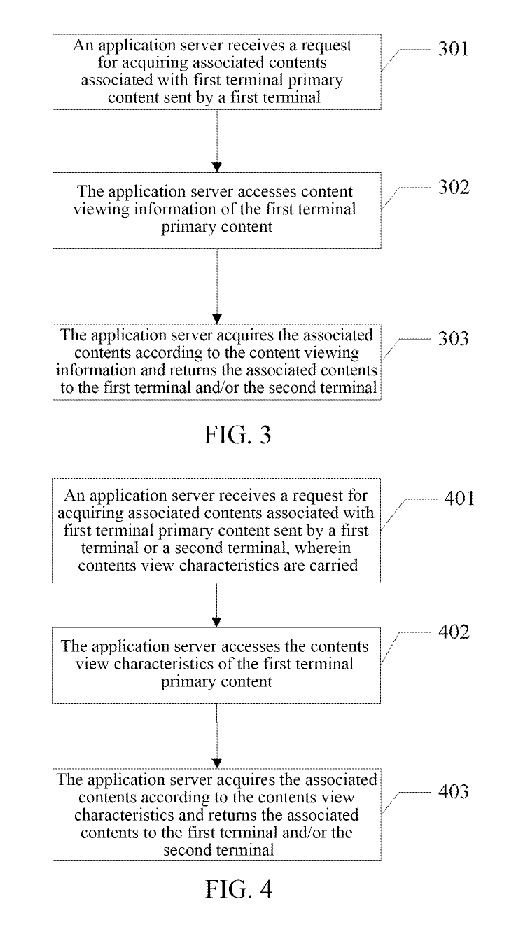

It is an application synchronization method according to the embodiment 3 of the present invention, in the embodiment 3, a terminal outputting the primary content is called a first terminal (such as a smart television set-top box), but a terminal sending a request for acquiring associated contents and receiving the associated contents can be either the first terminal or another associated terminal which is called a second terminal (such as a smartphone or a tablet computer), and as shown in FIG. 4, the method includes the following steps.

In step 401, an application server receives a request for acquiring associated contents associated with the first terminal primary content sent by a first terminal or a second terminal, wherein contents view characteristics are carried.

The first terminal primary content is for example a live television program, and the first terminal or the second terminal sends the request for acquiring the associated contents to request to acquire the associated contents associated with the primary content, and the contents view characteristics are carried in the request for acquiring the associated contents.

The contents view characteristics include but not limited to a digital fingerprint or a digital watermark.

Specifically, the contents view characteristics at least can be acquired by means of:

the first terminal extracting multimedia cache information in the cache of the primary content of the first terminal, and acquiring the contents view characteristics through a media characteristic analysis; or, the second terminal shooting a screenshot picture of the first terminal primary content, and acquiring the contents view characteristics through the media characteristic analysis.

In step 402, the application server accesses the contents view characteristics of the first terminal primary content.

In step 403, the application server acquires the associated contents according to the contents view characteristics and returns the associated contents to the first terminal or the second terminal.

Specifically, the step of the application server acquiring the associated contents according to the contents view characteristics includes:

the application server maintaining an association relation between the first terminal primary content and the associated contents;

the application server recognizing the first terminal primary content according to the contents view characteristics; and

the application server acquiring the associated contents associated with the first terminal primary content based on the association relation.

Besides the above embodiments, other possible implementation ways include: the second terminal sending the request for acquiring the associated contents, and the first terminal outputting the primary content receiving and outputting the associated contents, but in the practical applications, the implementation way is complicated when compared to the other implementation ways.

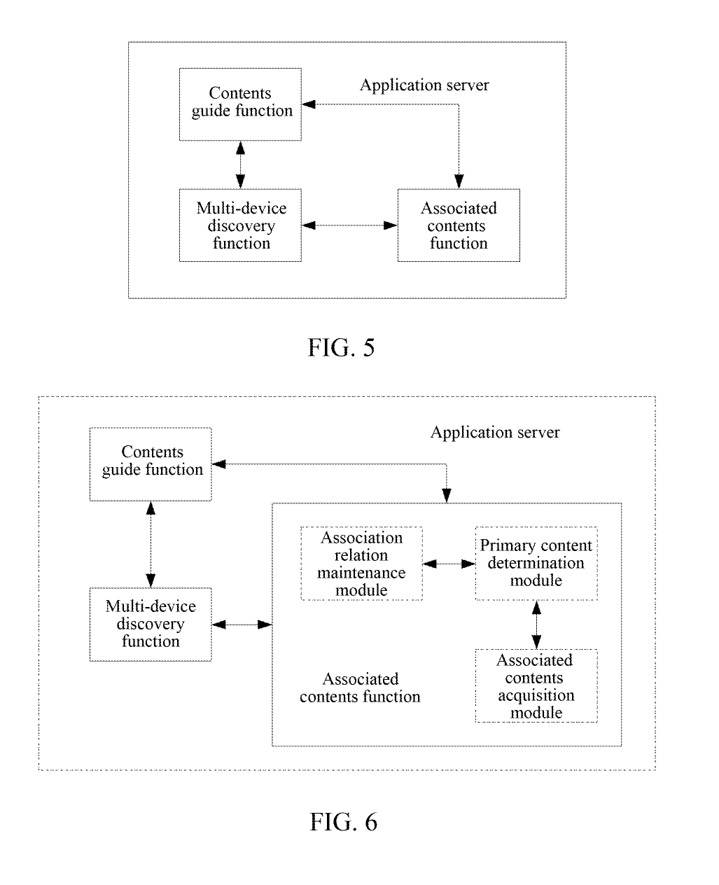

In order to implement the above method embodiments, the patent document also provides an application server, and shown in FIG. 5, the application server includes:

a contents guide function, used to: receive a request for acquiring associated contents associated with first terminal primary content sent by a first terminal or a second terminal, and send associated contents acquired by an associated contents function to the first terminal and/or the second terminal;

a multi-device discovery function, used to: access content viewing information of the first terminal primary content; and

an associated contents function, used to: acquire the associated contents according to the content viewing information.

Alternatively, the multi-device discovery function is also used to: interact with a third-party support server, and subscribe to a presence state of the first terminal primary content; and access the content viewing information of the first terminal primary content based on the presence state of the first terminal primary content.

Alternatively, the request for acquiring the associated contents carries the content viewing information of the first terminal primary content, and the multi-device discovery function accesses the content viewing information of the first terminal primary content based on the request for acquiring the associated contents.

Specifically, as shown in FIG. 6, the associated contents function includes:

an association relation maintenance module, used to maintain an association relation between the first terminal primary content and the associated contents;

a primary content determination module, used to determine the first terminal primary content according to the content viewing information; and

an associated contents acquisition module, used to acquire the associated contents associated with the first terminal primary content based on the association relation.

As mentioned above, the content viewing information at least includes one of the following: content metadata, a viewing progress and contents view characteristics. Specifically, the content metadata include a channel ID or a program ID; the viewing progress includes a viewing status or elapsed time; and the contents view characteristics include a digital fingerprint or a digital watermark.

Corresponding to the method embodiment 3, as shown in FIG. 7, alternatively the associated contents function includes:

an association relation maintenance module, used to maintain an association relation between the first terminal primary content and the associated contents;

a content recognition module, used to request a content recognition server to recognize the first terminal primary content according to the contents view characteristics; and

an associated contents acquisition module, used to acquire the associated contents associated with the first terminal primary content based on the association relation.

Preferably, the associated contents function acquires a plurality of different associated contents associated with the first terminal primary content; and the contents guide function sends one or a plurality of associated contents in the plurality of different associated contents to the first terminal and/or the second terminal.

The method of the patent document is described from the perspective of the application server in the forgoing embodiments, and the method of the patent document will be described from the perspective of the terminal in combination with the accompanying drawings below.

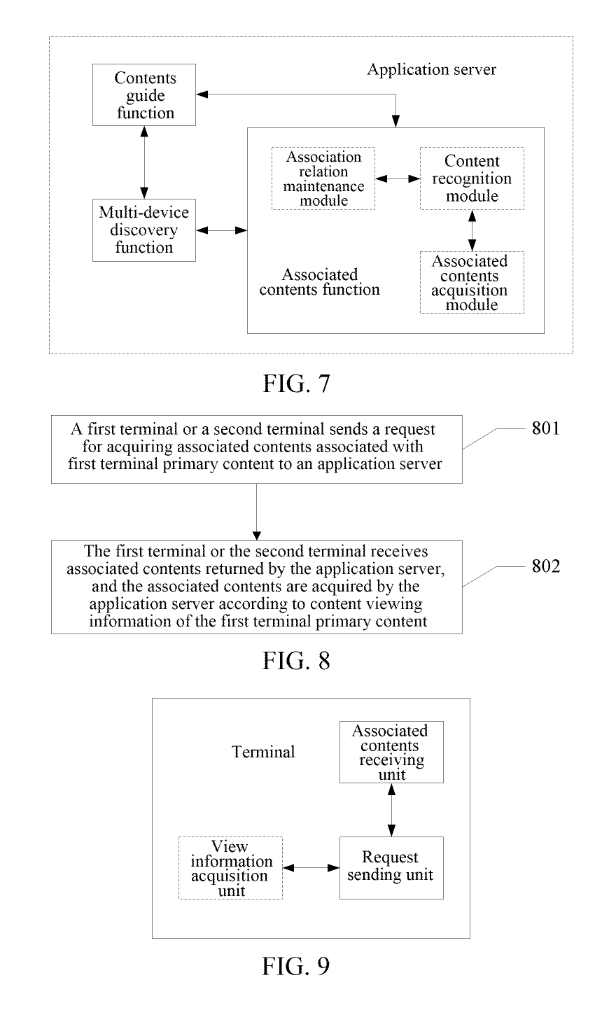

As shown in FIG. 8, the application synchronization method according to the embodiment 5 of the present invention includes the following steps.

In step 801, a first terminal or a second terminal sends a request for acquiring associated contents associated with first terminal primary content to an application server.

In step 802, the first terminal or the second terminal receives associated contents returned by the application server, and the associated contents are acquired by the application server according to content viewing information of the first terminal primary content.

Based on the embodiment shown in the FIG. 8, corresponding to the above method embodiment, alternatively, before the first terminal sends the request for acquiring the associated contents, the method also includes: the first terminal acquiring the content viewing information of the first terminal primary content; wherein the request for acquiring the associated contents carries the content viewing information.

Based on the embodiment shown in the FIG. 8, corresponding to the above method embodiment, another optional scheme is that, before the step of the second terminal sending the request for acquiring the associated contents, the method also includes: the second terminal receiving the content viewing information acquired and sent by the first terminal; wherein the request for acquiring the associated contents carries the content viewing information.

Based on the embodiment shown in the FIG. 8, corresponding to the above method embodiment, another optional scheme is that, before the step of the second terminal sending the request for acquiring the associated contents, the method also includes: the second terminal acquiring the content viewing information, wherein the content viewing information is the contents view characteristics; and the request for acquiring the associated contents carries the contents view characteristics.

As mentioned above, the content viewing information at least includes one of the following: content metadata, a viewing progress and contents view characteristics, specifically, the content metadata include but not limited to a channel ID or a program ID; the viewing progress includes but not limited to a viewing status or elapsed time; and the contents view characteristics include but not limited to a digital fingerprint or a digital watermark.

Preferably, the first terminal and/or the second terminal receive one or a plurality of associated contents in a plurality of different associated contents acquired by the application server.

Corresponding to the above method embodiment, the patent document also provides a terminal, and as shown in FIG. 9, the terminal includes:

a request sending unit, used to: send a request for acquiring associated contents associated with primary content of a current terminal or associated terminal to an application server; and

an associated contents receiving unit, used to: receive associated contents returned by the application server, wherein the associated contents are acquired by the application server according to content viewing information of the primary content.

Alternatively, as shown in the FIG. 9, the terminal also includes a view information acquisition unit.

Alternatively, when the current terminal outputs the primary content and sends the request for the associated contents, the view information acquisition unit is used to acquire the content viewing information of the primary content; and the request for acquiring the associated contents carries the content viewing information.

Alternatively, when the associated terminal outputs the primary content and the current terminal sends the request for the associated contents, the view information acquisition unit is used to receive the content viewing information of the primary content acquired and sent by the associated terminal; and the request for acquiring the associated contents carries the content viewing information.

Alternatively, when the current terminal outputs the primary content and the associated terminal sends the request for the associated contents, the view information acquisition unit is used to acquire and send the content viewing information of the primary content to the associated terminal; and the request for acquiring the associated contents carries the content viewing information.

The content viewing information at least includes one of the following: content metadata, a viewing progress and contents view characteristics.

The content metadata include but not limited to a channel ID or a program ID; the viewing progress includes but not limited to a viewing status or elapsed time; and the contents view characteristics include but not limited to a digital fingerprint or a digital watermark.

When the terminal is only used for outputting the associated contents or is simultaneously used for outputting the primary content and the associated contents, the associated contents receiving unit receives one or a plurality of associated contents in a plurality of different associated contents acquired by the application server.

The application example of an application synchronization system applying the method of the patent document will be given below, to further describe the patent document.

The user accesses communication services deployed by the service provider and/or the content provider through mobile and fixed communication terminals such as a mobile phone, a PC, a portable computer and a PDA and so on, and the access process is executed and completed by establishing a communication link between a communication terminal of the user and a communication service server with the help of abilities of the service-oriented communication client and the server, and the communication link is normally established and completed via the mobile communication networks such as GSM, UMTS, WIMAX and LTE networks and so on.

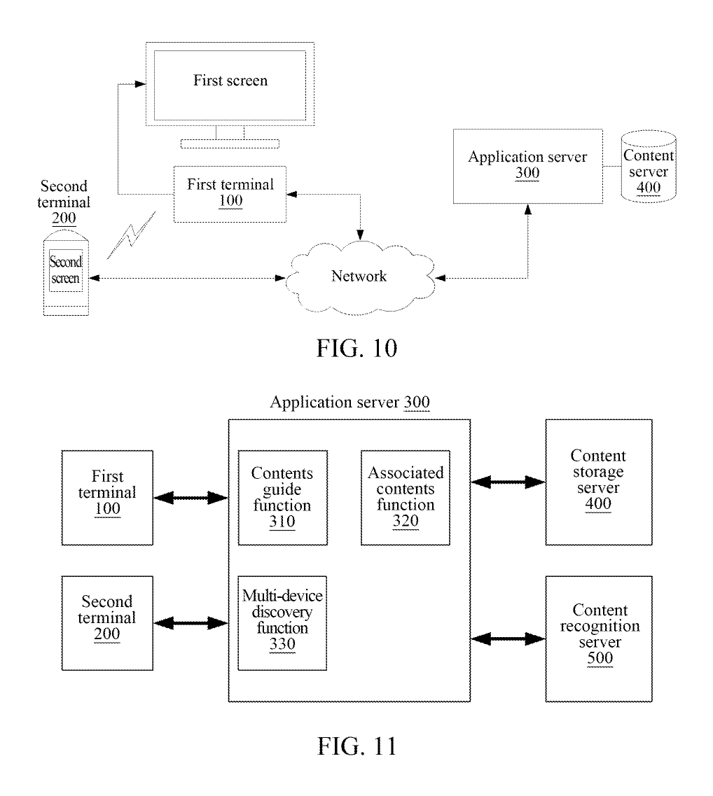

As shown in FIG. 10, the application synchronization system at least includes a first terminal 100, a second terminal 200 and an application server 300, wherein:

the first terminal 100 is responsible for receiving multimedia contents such as a television program and an OTT application according to the user selection, and performing signal processing on the received contents to complete decoding, and finally sending the decoded contents to a first screen to broadcast. Generally the first terminal 100 can be a Set-top Box, and the first screen is a display screen of the television.

The second terminal 200 is responsible for providing the receiving, processing and displaying of the multimedia contents related to applications of a second screen. Generally the second terminal 200 can be a personal mobile terminal such as a smartphone and a tablet computer and so on, and the second screen is a display screen of the above mobile terminal. Moreover, if communication links such as a WLAN and Wi-Fi exist between the second terminal 200 and the first terminal 100, the relevant information of the application synchronization can be directly interchanged between the second terminal 200 and the first terminal 100, which includes: the first terminal associating with view information of the primary content of the first screen (also called the first terminal primary content above).

The first terminal 100 and the second terminal 200 can perform the information interaction through the communication network and the application server.

The application server 300 is responsible for providing a service implementation ability of the application network side, that is, receiving the request for acquiring the associated contents sent by the above first terminal 100 or the second terminal 200, and according to the view information of the primary content carried in the request, accessing the content viewing information of the first terminal primary content, and acquiring the associated contents according to the content viewing information and returning the associated contents to the first terminal 100 and/or the second terminal 200; or, receiving the request for acquiring the associated contents, and accessing the content viewing information of the primary content based on a presence state of the primary content subscribed by interacting with a third-party support server, and then acquiring the associated contents according to the content viewing information and returning the associated contents to the first terminal 100 and/or the second terminal 200. Alternatively, the application server 300 requests a content server to recognize the contents view characteristics based on the view characteristics (such as a digital fingerprint) of the primary content, and then determines the primary content.

A content server 400 is responsible for providing a content management ability of the application network side, which includes: taking charge of storing the associated contents related to the primary content (as shown in FIG. 10, it can be separated as a content storage server), and taking charge of performing recognition on the contents view based on the view characteristics (such as the digital fingerprint) of the primary content of the first screen (as shown in FIG. 10, it can be separated as a content recognition server).

As shown in FIG. 11, the schematic diagram of the application server 300 includes the following function modules.

A Contents Guide Function 310, also called a contents guide unit, takes charge of querying to a Multi-device Discovery Function 330 for the view information of the primary content, to determine the primary content; alternatively, it takes charge of requesting a content recognition module 340 to recognize the view characteristics of the primary content, to determine the primary content; and it takes charge of requesting an Associated contents Function 320 to acquire associated contents associated with the primary content.

The Associated contents Function 320, also called an associated contents unit, takes charge of establishing and maintaining an association between the associated contents and the primary content; and determining the corresponding primary content according to the content viewing information or requesting a content recognition server 500 to recognize the primary content according to the contents view characteristics; and it takes charge of contacting with a content storage server 400 to acquire the associated contents according to a request of the contents management function 310.

The Multi-device Discovery Function 330, also called a multi-device discovery unit, is responsible for discovering the view information of the primary content according to the request of the contents management function 310.

In a particular relationship with the patent document, the first terminal 100 and the second terminal 200 include the following function modules: a request sending unit and an associated contents receiving unit,

the request sending unit is used to send a request for acquiring associated contents associated with primary content of a current terminal or associated terminal to an application server; and

the associated contents receiving unit is used to receive associated contents returned by the application server, and the associated contents are acquired by the application server according to content viewing information of the primary content.

As mentioned above, when the first terminal 100 outputs the primary content, the content viewing information can be acquired by the application server subscribing to a presence state of the first terminal primary content from a third-party support server, and then accessing the content viewing information of the first terminal primary content based on the presence state of the first terminal primary content.

Another optional implementation scheme is that, the first terminal 100 or the second terminal 200 carries the content viewing information in the request for acquiring the associated contents. Correspondingly, the first terminal 100 or the second terminal 200 also includes a view information acquisition unit, and when the first terminal 100 outputs the primary content and sends the request for the associated contents, the view information acquisition unit is used to acquire the content viewing information of the primary content; when the associated terminal outputs the primary content and the current terminal sends the request for the associated contents, for example, when the first terminal 100 outputs the primary content and the second terminal 200 sends the request for the associated contents, the view information acquisition unit of the second terminal receives the content viewing information of the primary content acquired and sent by the associated terminal namely the first terminal 100; and when the current terminal outputs the primary content and the associated terminal sends the request for the associated contents, for example, when the first terminal 100 outputs the primary content and the second terminal 200 sends the request for the associated contents, the view information acquisition unit of the first terminal 100 acquires and sends the content viewing information of the primary content to the associated terminal namely the second terminal 200.

The content viewing information mentioned above at least includes:

content metadata: a channel ID, a program ID and a timestamp;

a viewing progress: a viewing status and elapsed time;

contents view characteristics: a digital fingerprint and a digital watermark.

Specifically, the contents view characteristics at least can be acquired by means of: the first terminal 100 extracting multimedia cache information in the cache of the primary content of the first terminal 100, and acquiring the contents view characteristics through a media characteristic analysis; or,

the second terminal 200 shooting a screenshot picture of the primary content of the first terminal 100, and acquiring the contents view characteristics through the media characteristic analysis.

According to the above description, the acquisition of the associated contents includes but not limited to the following three ways:

Way 1. Directly requesting to acquire the associated contents

the first terminal 100 or the second terminal 200 requests the application server 300 for acquiring the associated contents.

Way 2. Requesting to push the associated contents

the first terminal 100 requests the application server 300 to acquire and push the associated contents to the second terminal 200.

Way 3. Informing the second terminal of acquiring the associated contents

the first terminal 100 informs the second terminal 200 of requesting the application server 300 to acquire the associated contents according to the content viewing information.

Specifically, certain two ways in the above ways also can be combined based on the implementation possibility, for example, the first terminal 100 requests to acquire the associated contents and pushes the associated contents to the second terminal 200.

With the application synchronization method, the application server and the terminal in the patent document, the terminal sends a request for acquiring associated contents associated with the terminal primary content to the application server, and the application server acquires the associated contents associated with the terminal primary content by accessing content viewing information of the terminal primary content, which reduces the production cost of the primary content and the acquisition complexity of the associated contents, thereby implementing the scheme of efficiently synchronizing the associated contents in the second screen application.

The ordinary person skilled in the art can understand that all or part of the steps in the above method can be completed by a program instructing related hardware, and the program can be stored in a computer readable memory medium, such as a read-only memory, disk or optical disk and so on. Alternatively, all or part of the steps of the above embodiments also can be implemented by using one or multiple integrated circuits. Correspondingly, each module/unit in the above embodiments can be implemented in a form of hardware, and also can be implemented in a form of software function module. The patent document is not limited to any combination of hardware and software in a specific form.

The modules in the system/apparatus/device described in the embodiments of the present invention are only an example divided according to the functions of the modules, understandably, in the case that the system/apparatus/device implements the same function, the people skilled in the art can give one or a plurality of other function dividing ways, and any one or a plurality of function modules therein can be implemented by using one functional entity apparatus or unit during the specific application, and undeniably the above transformation ways are all within the protection scope of the patent document.

### INDUSTRIAL APPLICABILITY

With the application synchronization method, the application server and the terminal provided in the embodiments of the present invention, the terminal sends a request for acquiring associated contents associated with terminal primary content to the application server, and the application server acquires the associated contents associated with the terminal primary content by accessing content viewing information of the terminal primary content, which reduces the production cost of the primary content and the acquisition complexity of the associated contents, thereby implementing the scheme of efficiently synchronizing the associated contents in the second screen application.

What is claimed is:

1. A method for application synchronization, comprising:
an application server receiving a request for acquiring associated contents associated with first terminal primary content sent by a first terminal or a second terminal;
the application server accessing content viewing information of the first terminal primary content; and
the application server acquiring the associated contents according to the content viewing information and returning the associated contents to the first terminal and/or the second terminal.

2. The method according to claim 1, wherein, before the step of the application server accessing content viewing information of the first terminal primary content, the method further comprises: the application server interacting with a third-party support server, and subscribing to a presence state of the first terminal primary content; and
the application server accessing the content viewing information of the first terminal primary content based on the presence state of primary content.

3. The method according to claim 1, wherein, the request for acquiring the associated contents carries the content viewing information of the first terminal primary content, and the application server accesses the content viewing information of the first terminal primary content based on the request for acquiring the associated contents.

4. The method according to claim 1, wherein, the step of the application server acquiring the associated contents according to the content viewing information comprises:
the application server maintaining an association relation between the first terminal primary content and the associated contents;
the application server determining the first terminal primary content according to the content viewing information; and
the application server acquiring associated contents associated with the first terminal primary content based on the association relation.

5. The method according to claim 1, wherein, the content viewing information at least comprises one of the following: content metadata, a viewing progress and contents view characteristics,
Preferably, the content metadata comprise a channel ID or a program ID; the viewing progress comprises a viewing status or elapsed time; and the contents view characteristics comprise a digital fingerprint or a digital watermark.

6. (canceled)

7. The method according to claim 4, wherein, the content viewing information is contents view characteristics, and the step of the application server determining the first terminal primary content according to the content viewing information comprises:
the application server requesting a content recognition server to recognize the first terminal primary content according to the contents view characteristics; and
the application server determining the first terminal primary content according to a recognition result of the content recognition server;
or
wherein, the step of the application server acquiring the associated contents associated with the first terminal primary content based on the association relation comprises:
the application server requesting a content storage server to acquire the associated contents based on the association relation; or,
the application server acquiring the associated contents from a local cache based on the association relation.

8. (canceled)

9. The method according to claim 1, wherein,
the application server acquires a plurality of different associated contents associated with the first terminal primary content; and
the application server returns one or a plurality of associated contents in the plurality of different associated contents to the first terminal and/or the second terminal.

10. A method for application synchronization, comprising:
a first terminal or a second terminal sending a request for acquiring associated contents associated with first terminal primary content to an application server; and
the first terminal or the second terminal receiving associated contents returned by the application server, wherein the associated contents are acquired by the application server according to content viewing information of the first terminal primary content.

11. The method according to claim 10, wherein, before the step of the first terminal sending the request for acquiring the associated contents, the method further comprises: the first terminal acquiring the content viewing information of the first terminal primary content; wherein the request for acquiring the associated contents carries the content viewing information;
or
wherein, before the step of the second terminal sending the request for acquiring the associated contents, the method further comprises: the second terminal receiving content viewing information sent by the first terminal; wherein the request for acquiring the associated contents carries the content viewing information.

12. (canceled)

13. The method according to claim 10, wherein, the content viewing information at least comprises one of the following: content metadata, a viewing progress and contents view characteristics,
preferably, the content metadata comprise a channel ID or a program ID; the viewing progress comprises a viewing status or elapsed time; and the contents view characteristics comprise a digital fingerprint or a digital watermark.

14. The method according to claim 10, wherein, before the step of the second terminal sending the request for acquiring the associated contents, the method further comprises: the second terminal acquiring the content viewing information, wherein the content viewing information is contents view characteristics; and the request for acquiring the associated contents carries the contents view characteristics.

15. (canceled)

16. The method according to claim 10, wherein, the first terminal and/or the second terminal receive one or a plurality of associated contents in a plurality of different associated contents acquired by the application server.

17. An application server, comprising:
a contents guide function, configured to: receive a request for acquiring associated contents associated with first terminal primary content sent by a first terminal or a second terminal, and send associated contents acquired by an associated contents function to the first terminal and/or the second terminal;
a multi-device discovery function, configured to: access content viewing information of the first terminal primary content; and
the associated contents function, configured to: acquire the associated contents according to the content viewing information.

18. The application server according to claim 17, wherein, the multi-device discovery function is further configured to: interact with a third-party support server, and subscribe to a presence state of the first terminal primary content; and access the content viewing information of the first terminal primary content based on the presence state of the first terminal primary content;
or
the request for acquiring the associated contents carries the content viewing information of the first terminal primary content, and the multi-device discovery function is configured to: access the content viewing information of the first terminal primary content based on the request for acquiring the associated contents.

19. (canceled)

20. The application server according to claim 17, wherein, the associated contents function comprises:
an association relation maintenance module, configured to: maintain an association relation between the first terminal primary content and the associated contents;
a primary content determination module, configured to: determine the first terminal primary content according to the content viewing information; and
an associated contents acquisition module, configured to: acquire associated contents associated with the first terminal primary content based on the association relation;
or
the associated contents function is configured to: acquire a plurality of different associated contents associated with the first terminal primary content; and the contents guide function is configured to: send one or a plurality of associated contents in the plurality of different associated contents to the first terminal and/or the second terminal.

21. The application server according to claim 17, wherein, the content viewing information at least comprises one of the following: content metadata, a viewing progress and contents view characteristics;
or
the content viewing information is contents view characteristics, and the associated contents function comprises:
an association relation maintenance module, configured to: maintain an association relation between the first terminal primary content and the associated contents;
a content recognition module, configured to: request a content recognition server to recognize the first terminal primary content according to the contents view characteristics; and
an associated contents acquisition module, configured to: acquire associated contents associated with the first terminal primary content based on the association relation.

22-23. (canceled)

24. A terminal, comprising:
a request sending unit, configured to: send a request for acquiring associated contents associated with primary content of a current terminal or associated terminal to an application server; and
an associated contents receiving unit, configured to: receive associated contents returned by the application server, wherein the associated contents are acquired by the application server according to content viewing information of the primary content.

25. The terminal according to claim 24, further comprising: a view information acquisition unit, configured to: when the current terminal outputs the primary content and sends a request for the associated contents, acquire the content viewing information of the primary content; wherein the request for acquiring the associated contents carries the content viewing information;
or
further comprising: a view information acquisition unit, configured to: when the associated terminal outputs the primary content and the current terminal sends a request for the associated contents, receive the content viewing information of the primary content acquired and sent by the associated terminal; wherein the request for acquiring the associated contents carries the content viewing information;
or
further comprising: a view information acquisition unit, configured to: when the current terminal outputs the primary content and the associated terminal sends a request for the associated contents, acquire and send the content viewing information of the primary content to the associated terminal; wherein the request for acquiring the associated contents carries the content viewing information.

26-27. (canceled)

28. The terminal according to claim 24, wherein, the content viewing information at least comprises one of the following: content metadata, a viewing progress and contents view characteristics.

29. The terminal according to claim 24, wherein, the associated contents receiving unit is configured to: when the terminal is only used for outputting the associated contents or is simultaneously used for outputting the primary content and the associated contents, receive one or a plurality of associated contents in a plurality of different associated contents acquired by the application server.
